(19) United States
(12) Patent Application Publication
(10) Pub. No.: US 2016/0028669 A1
(43) Pub. Date: Jan. 28, 2016

(54) METHOD OF PROVIDING CONTENT AND ELECTRONIC DEVICE THEREOF

(71) Applicant: Samsung Electronics Co., Ltd., Gyeonggi-do (KR)

(72) Inventors: Kyung-Hee Lee, Gyeonggi-do (KR); Jin-Hong Jeong, Gyeonggi-do (KR); Seok-Kyoun Park, Gyeonggi-do (KR); Tae-Gun Park, Gyeonggi-do, (KR); Ki-Huk Lee, Gyeonggi-do (KR); Seung-Cheol Lee, Seoul (KR); Ju-Yeong Lee, Seoul (KR)

(21) Appl. No.: 14/809,111

(22) Filed: Jul. 24, 2015

(30) Foreign Application Priority Data
Jul. 24, 2014 (KR) 10-2014-0094060

(51) Int. Cl. H04L 12/58; G06F 3/0482; G06F 3/0484; G06F 3/041; G06F 3/0488

(52) U.S. Cl. CPC H04L 51/046; G06F 3/041; G06F 3/0488; G06F 3/04842; G06F 3/0482

(57) ABSTRACT

According to various embodiments, a method for providing content in an electronic device includes: providing content through a display functionally connected to the electronic device; selecting at least one object included in the content based on a user input; and connecting an input comment to the at least one selected object when the comment corresponding to the at least one selected object is input. The method for providing content in an electronic device can be implemented through various embodiments of the present disclosure.

### CROSS-REFERENCE TO RELATED APPLICATION AND CLAIM OF PRIORITY

The present application is related to and claims benefit under 35 U.S.C. §119(a) to Korean Application Serial No. 10-2014-0094060, which was filed in the Korean Intellectual Property Office on Jul. 24, 2014, the entire content of which is hereby incorporated by reference.

### TECHNICAL FIELD

Various embodiments of the present disclosure relate to a method and device for providing content.

### BACKGROUND

Electronic devices can provide content, such as a still image or a moving image, to a user through a display included therein. In addition, the electronic devices can create content. For example, the electronic devices can create content, such as a still image or a moving image, by a user input (e.g., a touch or a key input). Recently, the user can make a still image or a moving image in the electronic devices using an electronic pen functionally connected to the electronic devices.

With the development of the Internet, social network services are developing. Through the social network services, the electronic devices can share content or opinions on the content with other electronic devices.

### SUMMARY

According to the related art, electronic devices share content, such as a still image or a moving image, with other electronic devices through social network services. In certain embodiments, a user views or inputs information (e.g., opinions or comments) related to the content through the electronic devices. Since the user cannot designate information on a part of content through the electronic devices, the electronic devices are difficult to input or provide the information related to only a part of the content in such a manner that the information is distinguished from information related to another part.

Furthermore, according to the related art, when a user views information related to content in social network services, information associated with the entire content is provided. Accordingly, the electronic devices have difficulty identifying only information on a part of the content.

To address the above-discussed deficiencies, it is a primary object to provide a method and device for inputting or providing information on a part included in content in an electronic device.

For solving the aforementioned problems or other problems, a method for providing content in an electronic device, according to various embodiments, includes providing content through a display functionally connected to an electronic device, acquiring a user input corresponding to at least one object included in the content, and acquiring, through the electronic device, a comment that is able to be provided through the electronic device or another electronic device in relation to the at least one object.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the present For a more complete understanding of the present disclosure and its advantages, reference is now made to the following description taken in conjunction with the accompanying drawings, in which like reference numerals represent like parts:

FIG. 1 illustrates a network environment including an electronic device, according to various embodiments of the present disclosure;

FIG. 2 illustrates a system for providing information related to an object included in content, according to various embodiments of the present disclosure;

FIG. 3 illustrates a content management module for providing content in an electronic device, according to various embodiments of the present disclosure;

FIG. 4 illustrates a screen configuration for providing content in an electronic device, according to various embodiments of the present disclosure;

FIGS. 5A to 6B illustrate methods of selecting an object and including information in the object in an electronic device, according to various embodiments of the present disclosure;

FIGS. 7A to 7C illustrate methods of displaying content and information corresponding to the content, according to various embodiments of the present disclosure;

FIG. 8 illustrates an electronic device according to various embodiments of the present disclosure;

FIG. 9 illustrates a communication protocol between a plurality of electronic devices according to various embodiments of the present disclosure;

FIG. 10 illustrates a procedure for providing content in an electronic device, according to various embodiments of the present disclosure; and

FIG. 11 illustrates a procedure for providing content in an electronic device, according to various embodiments of the present disclosure.

### DETAILED DESCRIPTION

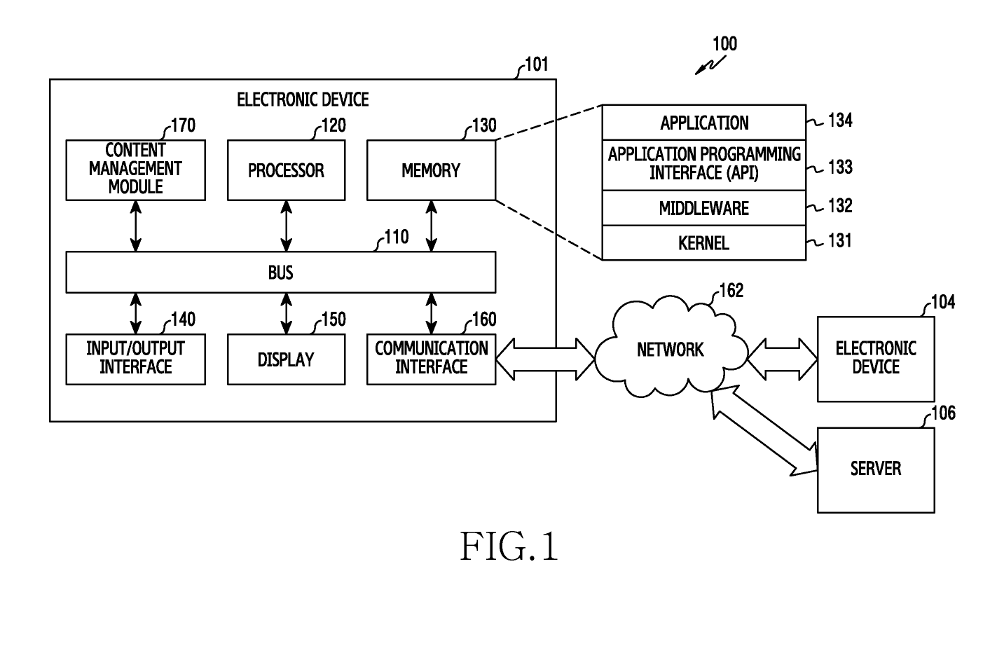

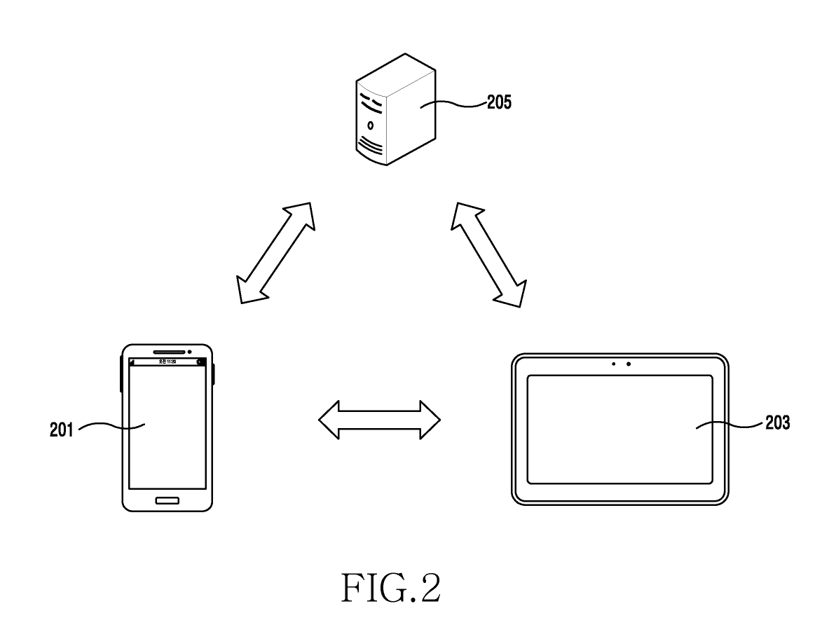

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. Hereinafter, various embodiments of the present disclosure will be described with reference to the accompanying drawings. The present disclosure may be modified in various forms and include various embodiments, but specific examples are illustrated in the drawings and described in the description. However, the description is not intended to limit the present disclosure to the specific embodiments, and it shall be appreciated that all the changes, equivalents and substitutions belonging to the idea and technical scope of the present disclosure are included in the present disclosure. In the description of the drawings, identical or similar reference numerals arc used to designate identical or similar elements.

The term “include” or “may include” refers to the existence of a corresponding disclosed function, operation or component which can be used in various embodiments of the present disclosure and does not limit one or more additional functions, operations, or components. Further, as used in embodiment of the present disclosure, the terms “include”, “have” and their conjugates may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” include A, include B, or include both A and B.

The expression “1,” “2,” “first,” or “second” used in various embodiments of the present disclosure modifies various components of various embodiments but does not limit the corresponding components. For example, the above expressions do not limit the sequence and/or importance of the elements. The expressions are used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element be directly coupled or connected to the second component, and a third component element be “coupled” or “connected” between the first and second component elements. Conversely, when one component element is “directly coupled' or “directly connected” to another component element, it be construed that a third component element does not exist between the first component element and the second component element.

In the present disclosure, the terms are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

According to various embodiments of the present disclosure, an electronic device is a device with a touch screen. For example, the electronic device includes at least one of a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mounted-device (HMD) such as electronic glasses, electronic clothes, an electronic bracelet, an electronic necklace, an electronic appcessory, an electronic tattoo, or a smart watch).

According to some embodiments, the electronic device is a smart home appliance with a camera function. The smart home appliance as an example of the electronic device includes at least one of, for example, a television, a Digital Video Disk (DVD) player, an audio system, a refrigerator, an air conditioner, a vacuum cleaner, an oven, a microwave oven, a washing machine, an air cleaner, a set-top box, a TV box (e.g., SAMSUNG HOMESYNC™, APPLE TV™, or GOOGLE TV™), a game console, an electronic dictionary, an electronic key, a camcorder, and an electronic picture frame,

According to an embodiment, an electronic device includes at least one of various medical devices such as a magnetic resonance angiography (MRA) scanner, a magnetic resonance imaging (MRI) scanner, a computed tomography (CT) scanner, a scanner, an ultrasonograph, or the like, a navigation device, a Global Positioning System (GPS) receiver, an Event Data Recoder (EDR), a Flight Data Recoder (FDR), a vehicle infotainment device, an electronic equipment for ship (for example a ship navigation device and gyro-compass and the like, avionics, a security device, a head unit for vehicle, an industrial or household robot, ATM(automatic teller machine) in banking facilities or POS(point of sales) in stores.

According to another embodiment, the electronic devices includes at least one of furniture or a part of a building/structure having a communication function, electronic boards, electronic signature receiving devices, projectors, or various measuring equipment (e.g., equipment for a water supply, an electricity, gases or radio waves). An electronic device according to various embodiments of the present disclosure is a combination of one or more of above described various devices. Also, an electronic device according to various embodiments of the present disclosure is a flexible device. Also, an electronic device according to various embodiments of the present disclosure is not limited to the above described devices.

Hereinafter, an electronic device according to various embodiments of the present disclosure will be described with reference to the accompanying drawings. In various embodiments, the term “user” indicates a person using an electronic device or a device (e.g. an artificial intelligence electronic device) using an electronic device.

FIG. 1 is a block diagram illustrating a configuration 100 of an electronic device according to various embodiments of the present disclosure.

Referring to FIG. 1, the electronic device 101 includes a bus 110, a processor 120, a memory 130, an input/output interface 140, a display 150, a communication interface 160, and a content management module 170.

The bus 110 is a circuit that connects the aforementioned elements and transfers communication (e.g., a control messages) between the aforementioned elements.

For example, the processor 120 receives instructions from the aforementioned other elements (e.g., the memory 130, the input/output interface 140, the display 150, the communication interface 160, or the content management module 170) through the bus 110, decode the received instructions, and perform calculation or data processing according to the decoded instructions.

The memory 130 stores instructions or data received from the processor 120 or the other elements (e.g., the input/output interface 140, the display 150, the communication interface 160, the content management module 170, or the like) or generated by the processor 120 or the other elements. The memory 130 includes programming modules such as a kernel 131, middleware 132, an Application Programming Interface (API) 133, and applications 134. The aforementioned programming modules are formed of software, firmware, hardware, or a combination of two or more thereof.

The kernel 131 controls or manages system resources (e.g., the bus 110, the processor 120, the memory 130, and the like) used to perform operations or functions implemented in the remaining programming modules, for example, the middleware 132, the API 133, and the applications 134. In addition, the kernel 131 provides an interface through which the middleware 132, the API 133, or the applications 134 accesses the individual elements of the electronic device 101 to control or manage them.

The middleware 132 functions as a relay to allow the API 133 or the applications 134 to communicate with the kernel 131 to transfer data. Furthermore, in relation to task requests received from the applications 134, the middleware 132 performs a control (e.g., scheduling or load-balancing) for the task requests by using, for example, a method of assigning a priority for using system resources (e.g., the bus 110, the processor 120, the memory 130, and the like) of the electronic device 101 to at least one of the applications 134.

The API 133 is an interface through which the applications 134 controls functions provided by the kernel 131 or the middleware 132 and includes at least one interface or function (e.g., instruction) for file control, window control, image processing, or text control.

According to various embodiments, the applications 134 includes a Short Message Service (SMS)/Multimedia Message Service (MMS) application, an e-mail application, a calendar application, an alarm application, a health care application (e.g., an application for measuring a work rate or a blood sugar), an environment information application (e.g., an application for providing atmospheric pressure, humidity), or temperature information). The applications 134 include an application related to an information exchange between the electronic device 101 and an external electronic device (e.g., an electronic device 104). The application related to the information exchange includes, for example, a notification relay application for transferring particular information to the external electronic device or a device management application for managing the external electronic device.

For example, the notification relay application includes a function of transferring notification information generated by other applications of the electronic device 101 (e.g., the SMS/MMS application, the e-mail application, the health care application, or the environmental information application) to the external electronic device (e.g., the electronic device 104). The notification relay application receives notification information from the external electronic device (e.g., the electronic device 104), and provide the same to a user. For example, the device management application manages (e.g., install, delete, or update) a function for at least some parts of the external electronic device (e.g., the electronic device 104) communicating with the electronic device 101 (e.g., a function of turning on/off the external electronic device itself (or some components) or a function of adjusting luminance (or a resolution) of the display), applications operating in the external electronic device or services provided by the external electronic device (e.g., a call service and a message service).

According to various embodiments, the applications 134 include applications designated according to an attribute (e.g., a type) of the external electronic device (e.g., the electronic device 104). For example, when the external electronic device is an MP3 player, the applications 134 include an application related to the reproduction of music. Similarly, when the external electronic device is a mobile medical device, the application 134 includes an application related to health care. According to an embodiment, the applications 134 include at least one of an application designated for the electronic device 101 and an application received from the external electronic device (e.g., a server 106 or the electronic device 104).

The input/output interface 140 transfers instructions or data input from a user through an input/output device (e.g., sensors, a keyboard, or a touch screen) through the bus 110 to the processor 120, the memory 130, the communication interface 160, or the content management module 170. For example, the input/output interface 140 provides, to the processor 120, data for a user's touch input through the touch screen. Furthermore, through the input/output device (e.g., a speaker or a display), the input/output interface 140 outputs instructions or data received through the bus 110 from the processor 120, the memory 130, the communication interface 160, or the content management module 170. For example, the input/output interface 140 outputs voice data processed by the processor 120 to the user through the speaker.

The display 150 displays various types of information (e.g., multimedia data, text data, or the like) to a user.

The communication interface 160 connects communication between the electronic device 101 and the external device (e.g., the electronic device 104 or the server 160). For example, the communication interface 160 communicates with the external electronic device while being connected to a network 162 through wireless or wired communication. The wireless communication includes at least one of, for example, Wi-Fi (Wireless Fidelity), BLUETOOTH (BT), Near Field Communication (NFC), Global Positioning System (GPS) and cellular communication (e.g., Long Term Evolution (LTE), LTE-A, Code Division Multiple Access (CDMA), Wideband CDMA (WCDMA), Universal Mobile Telecommunication System (UNITS), Wireless Broadband (WiBro), and Global System for Mobile communication (GSM)). The wired communication includes at least one of, for example, a Universal Serial Bus (USB), a High Definition Multimedia Interface (HDMI), Recommended Standard 232 (RS-232), and a Plain Old Telephone Service (POTS).

According to one embodiment, the network 162 is a telecommunication network. The communication network includes at least one of a computer network, the Internet, the Internet of things, and a telephone network. According to an embodiment, protocols (e.g., a transport layer protocol, a data link layer protocol, or a physical layer protocol) for communication between the electronic device 101 and the external electronic device are supported by at least one of the applications 134, the API 133, the middleware 132, the kernel 131, and the communication interface 160.

The content management module 170 provides, through the display 150, content acquired through the other elements (e.g., the processor 120, the memory 130, the input/output interface 140, and the communication interface 160). According to an embodiment, the content management module 170 connects at least one object included in the content (e.g., a still image or a moving image) and a comment. Accordingly, the content management module 170 provides the comment corresponding to the at least one object based on a user input corresponding to the at least one object. In addition, the content management module 170 provides information on the at least one object based on a user input corresponding the comment that corresponds to the at least one object.

FIG. 2 illustrates a system for providing information related to an object included in content, according to various embodiments of the present disclosure.

Referring to FIG. 2, the system includes a first electronic device 201, a second electronic device 203, and a server 205. The first electronic device 201 transmits, to the server 205, at least one object included in content and information (e.g., a comment) mapped with the object. The server 205 updates pre-stored data therein based on the object and the information mapped with the object. The server 205 transmits the updated data to at least one of the first and second electronic devices 201, 203. The second electronic device 203 identifies the object or the information mapped with the object. When at least one piece of information (e.g., at least one comment) is selected, the first or second electronic device 201 or 203 identifies the object corresponding to the at least one piece of selected information. When at least one object is selected from content, the first or second electronic device 201 or 203 identifies information connected to the at least one selected object.

For example, the content includes a first object and a second object connected to a second comment. The first electronic device 201 acquires a first comment corresponding to the first object. The first electronic device 201 connects information (for example, identification information (e.g., a unique ID)) related to the first object and the first comment (e.g., “good”) to transmit the same to the server 205. The server 205 maps (connects) the first object and the first comment. The server 205 stores the identification information and mapping information of the comment. In addition, the server 205 transmits the mapping information to the first or second electronic device 201 or 203. Accordingly, the second electronic device 203 (or the first electronic device 201) provides the first comment based on the selection of the first object from the content. Furthermore, the second electronic device 203 (or the first electronic device 201) reproduces the first object or highlights the first object (e.g., provides the first object in such a manner that the first object is distinguished from other objects).

An object is defined by at least one of the first electronic device 201, the second electronic device 203, and the server 205.

According to certain embodiments, an object is defined based on a reference determined in the first electronic device 201 or a user input. For example, a user using the first electronic device 201 defines any one object included in content as the first object. In certain embodiments, the first electronic device 201 transmits the defined first object to the server 205.

According to an embodiment, an object is defined based on a reference determined in the second electronic device 203 or a user input. For example, in the second electronic device 203, any one object included in content is set as the second object. When the second object is selected in the second electronic device 203, the second electronic device 203 receives the second object and the mapping information from the server 205 to provide the same.

According to certain embodiments, the server 205 defines an object according to a predetermined reference (e.g., automatically).

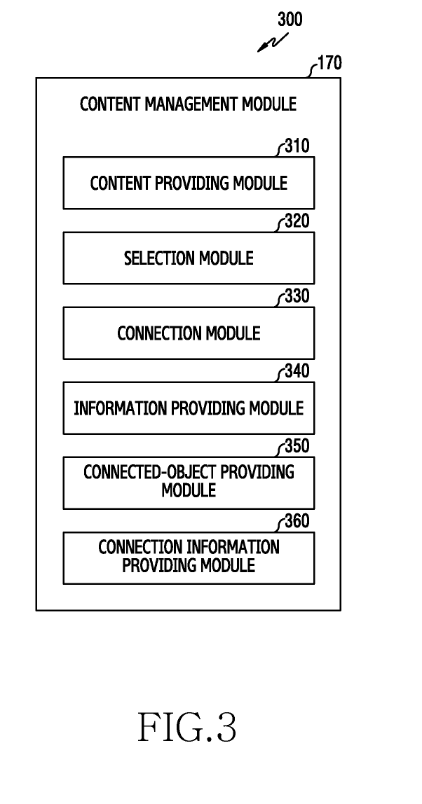

FIG. 3 is a block diagram 300 of a content management module 170 for providing content in an electronic device, according to various embodiments of the present disclosure. According to certain embodiments, at least one of the first electronic device 201, the second electronic device 203, and the server 205 which are illustrated in FIG. 2 includes the content management module 170.

The content management module 170 includes at least one of a content providing module 310, a selection module 320, a connection module 330, an information providing module 340, a connected-object providing module 350, and a connection information providing module 360.

The content providing module 310 provides content including objects. The content is, for example, data output through the display 150 and is not limited to a particular format. For example, the content is visual information such as a still image, a moving image, or a 3D image, each including a character, a symbol or sign, text, an icon or image, and the like.

According to certain embodiments, the objects are designated according to various conditions such as time, a creation tool, a region, a user, text, and the like.

According to certain embodiments, the objects are designated based on time information when the objects are created. For example, an object created at a first time (e.g., about 13:00) is designated as a first object, and an object created at a second time (e.g., about 13:05) is designated as a second object.

According to certain embodiments, the objects are designated based on the sequence in which the objects are created. For example, an object that a user primarily creates is designated as a first object, and an object that the user secondarily creates is designated as a second object.

According to certain embodiments, the objects are designated based on tools by Which the objects are created. For example, an object created using an electronic pen is designated as a first object, and an object created by a user's hand is designated as a second object.

According to certain embodiments, the objects are designated based on information in which the objects are stored. For example, when a partial region of content is selected by a user input, an object in a first region is designated as a first object, and an object in a second region is designated as a second object.

According to certain embodiments, the objects are designated based on user information. For example, an object designated by a first user is designated as a first object, and an object designated by a second user is designated as a second object.

According to certain embodiments, the objects are designated based on text. For example, the objects are designated in units of characters, words, sentences, or paragraphs of input text.

According to various embodiments, a method of designating an object is not limited to the above-described methods and is implemented through various methods.

According to certain embodiments, the content providing module 310, when providing content, transforms an object or add other data such that the object related to selected information is distinguished from other objects. For example, the content providing module 310 darkly displays the object related to the selected information, displays the object in different color from that of a non-selected object, or displays a unique ID of the object. The content providing module 310 adds another image to differentiate the object related to the selected information. For example, the content providing module 310, when creating content, stores the creation sequence of the content as an image. When information related to an object included in content is selected, the content providing module 310 reproduces an image of a time interval related to the object relevant to the information.

According to certain embodiments, the selection module 320 selects at least one object (hereinafter, for convenience of description, referred to as ‘selected object’) among designated objects. The selected object is, for example, an object selected based on a user input.

According to certain embodiments, the selection module 320 provides at least one selection menu (e.g., a hyperlink or a button) corresponding to at least one object included in content. In certain embodiments, the selection module 320 determines an object to be selected on the basis of a user input (e.g., a touch) corresponding to the at least one selection menu. For example, when content includes a first object and a second object, the selection module 320 provides a first selection menu corresponding to the first object and a second selection menu corresponding to the second object. When the selection module 320 acquires a user input for the first selection menu, the selection module 320 determines a first designated object as the selected object.

For example, when a unique ID related to an object is provided and the unique ID is input in a search region where the unique ID be searched, the selection module 320 selects the object corresponding to the input unique ID.

For example, when a closed curve is drawn with an electronic pen, the selection module 320 selects an object included in the region formed by the closed curve. The selection module 320 selects the corresponding object using an open curve.

For example, when content is a moving image, the selection module 320 selects at least a part of an object provided in the time domain of the content.

According to certain embodiments, the selection module 320 displays the selected object in such a manner that the selected object is distinguished from other objects. For example, when an object is selected, the selection module 320 changes the color of the object to a different color from those of other objects.

According to certain embodiments, when information corresponding to the selected object (hereinafter, for convenience of description, referred to as ‘response information’) is acquired, the connection module 330 connects the response information to the selected object. According to certain embodiments, the connection module 330 acquires information corresponding to the selected object.

According to certain embodiments, the connection module 330 acquires information input or drawn by a user. For example, the information includes text (e.g., a comment), an image, or audio data.

According to certain embodiments, the connection module 330 acquires information input at a designated time as the response information after at least one object is selected. For example, after at least one object is selected, when information is input to the electronic device within about one minute, the connection module 330 determines the information to be response information.

According to certain embodiments, the connection module 330 acquires information input in a designated region as response information. For example, when a writing input is acquired within a designated distance range (e.g., about 10 mm) from a region where at least one object is output, the connection module 330 determines the acquired writing input as response information.

According to certain embodiments, the connection module 330 acquires information corresponding to a plurality of objects. For example, when a plurality of objects is selected, the connection module 330 acquires information corresponding to all the objects.

According to certain embodiments, the connection module 330 connects response information to the selected object. For example, the connection module 330 connects the response information to the selected object and stores the same in a memory (e.g., the memory 130) functionally connected to the electronic device.

According to certain embodiments, the connection module 330 connects the response information to the selected object to transmit the same to another device (e.g., a server).

The information providing module 340 provides response information through the electronic device or an external device communicating with the electronic device.

According to certain embodiments, the information providing module 340 provides response information through a region where content is provided and another region. For example, when content information is provided through a first region of a display, the information providing module 340 provides response information through a second region of the display.

According to certain embodiments, the information providing module 340 displays a selected object or response information in such a manner that the selected object or the response information is distinguished from other objects or response information. For example, when an object or information is selected, the information providing module 340 changes the color of the selected object or response information to a different color from those of other objects or response information.

The connected-object providing module 350 selects a part (e.g., at least one comment) of one or more pieces of information (e.g., a plurality comments) connected to content (or all objects included in the content). Accordingly, the connected-object providing module 350 provides information related to the object connected to the partial information (hereinafter, for convenience of description, referred to as ‘connected object’).

For example, when content is connected to first information and second information, the connected-object providing module 350 selects the first information based on a user input. Accordingly, the connected-object providing module 350 provides output, display, reproduce, and the like.), through a display, a first object (e.g., only the first object) connected to the first information,

The connected-object providing module 350 selects the second information based on a user input. Accordingly, the connected-object providing module 350 outputs, through the display, a second object (e.g., only the second object) connected to the second information.

According to certain embodiments, the connected-object providing module 350 provides additional information related to a connected object corresponding to information. For example, when information (e.g., a comment) is selected, the connected-object providing module 350 displays (e.g., highlight) an object connected to the information in such a manner that the object is distinguished from other objects.

According to certain embodiments, based on selection of at least one of one or more objects connected to at least one piece of information, the connection information providing module 360 selects connection information connected to the at least one selected object.

The connection information providing module 360 selects a part of one or more pieces of information connected to content (or all objects included in the content). Accordingly, the connection information providing module 360 provides information related to the object connected to the partial information (hereinafter, for convenience of description, referred to as ‘connected object’).

For example, when content includes a first object and a second object, the connection information providing module 360 selects the first object based on a user input. Accordingly, the connection information providing module 360 outputs, through the display, only the comment connected to the first object among the comments connected to the content.

The connection information providing module 360 selects the second object based on a user input. Accordingly, the connection information providing module 360 outputs, through the display, only the comment connected to the second object among the comments connected to the content.

According to certain embodiments, the connection information providing module 360 provides connected information (e.g., a comment) corresponding to an object. For example, when an object is selected, the connection information providing module 360 displays information connected to the object in such a manner that the information is distinguished from other pieces of information. The object connected to the information is distinguished by changing at least one color, size, and shape. For example, the object connected to the information is highlighted.

According to certain embodiments, based on selection of at least one object, the connection information providing module 360 selects connection information connected to the at least one selected object.

According to various embodiments, an electronic device the first electronic device 201) includes a display (e.g., the display 150) for providing content and a content management module (e.g., the content management module 170) functionally connected to the display, wherein the content management module provides content through the display, acquire a user input corresponding to at least one object included in the content, and acquire a comment that is able to be provided through the electronic device or another electronic device (e.g., the second electronic device 203) in relation to the at least one object.

According to various embodiments, the at least one object is designated based on at least one of a user corresponding to the at least one object, and an output region, a generation time, and a generation method of the at least one object.

According to various embodiments, the content management module acquires an input corresponding to a region, where the at least one object is displayed, as the user input.

According to various embodiments, the content management module acquires at least one of unique information or an image corresponding to the at least one object as the user input.

According to various embodiments, the content management module provides the at least one selected object in such a manner that the selected object is distinguished from another object, based on the user input.

According to various embodiments, the content management module acquires information corresponding to a writing input acquired through the electronic device as the comment.

According to various embodiments, the content management module provides the comment based on another user input related to the at least one object.

According to various embodiments, the content management module reproduces only the at least one object of the content when the content includes a moving image.

According to various embodiments, the content management module acquires at least one of unique information or an image corresponding to the at least one object as the user input.

According to various embodiments, the content management module acquires the comment through a second region of the display when the content is provides through a first region of the display.

According to various embodiments, the content management module transmits the comment to a server to connect the comment to the at least one object.

According to various embodiments, an electronic device (e.g., the first electronic device 201) includes a display (e.g., the display 150) for providing content and a content management module (e.g., the content management module 170) functionally connected to the display, wherein the content management module provides the content through the display and provides, through the electronic device, at least one comment associated with at least one object among a plurality of comments corresponding to the content when a user input corresponding to the at least one object included in the content is acquired.

According to various embodiments, the content management module provides, through the electronic device, information associated with the at least one object when a user input corresponding to the at least one comment is acquired.

According to various embodiments, the content management module reproduces only the at least one object of the content when the at least one object is a moving image.

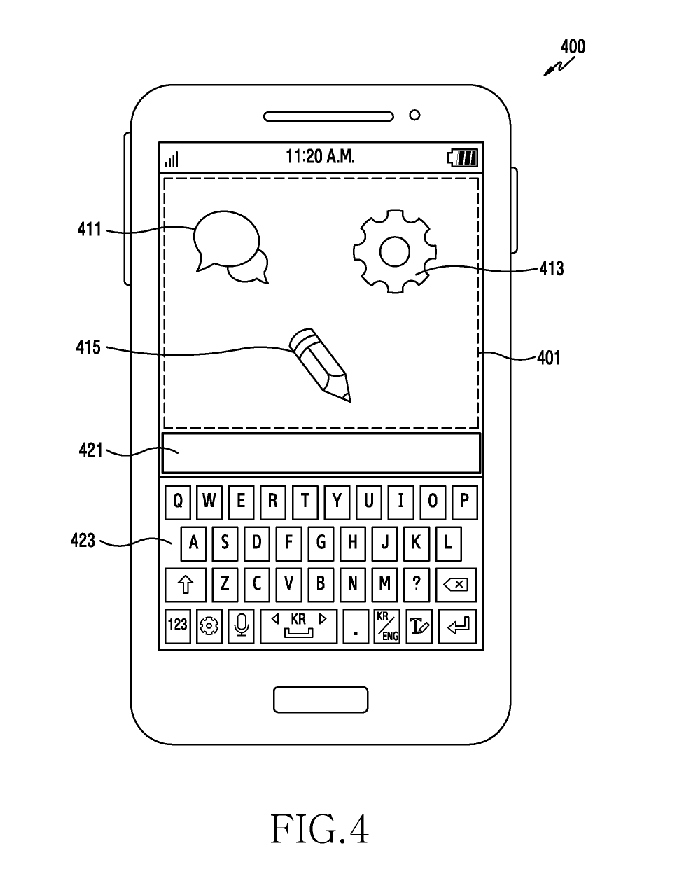

FIG. 4 illustrates a screen configuration for providing content in an electronic device, according to various embodiments of the present disclosure.

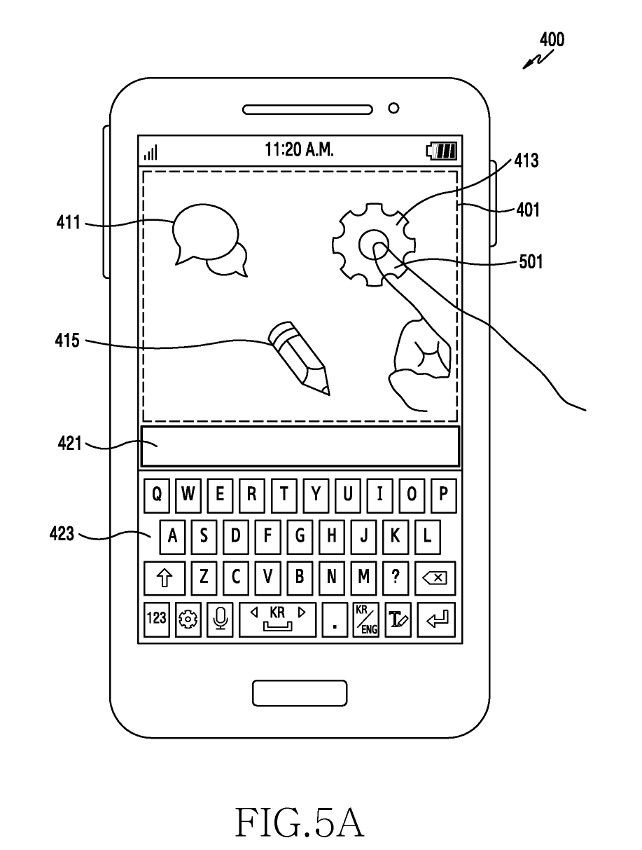

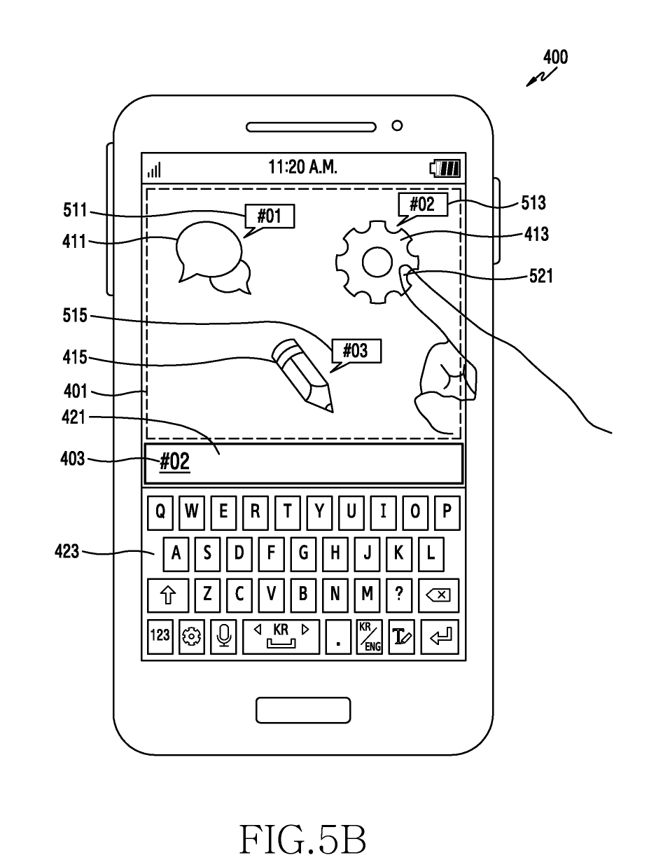

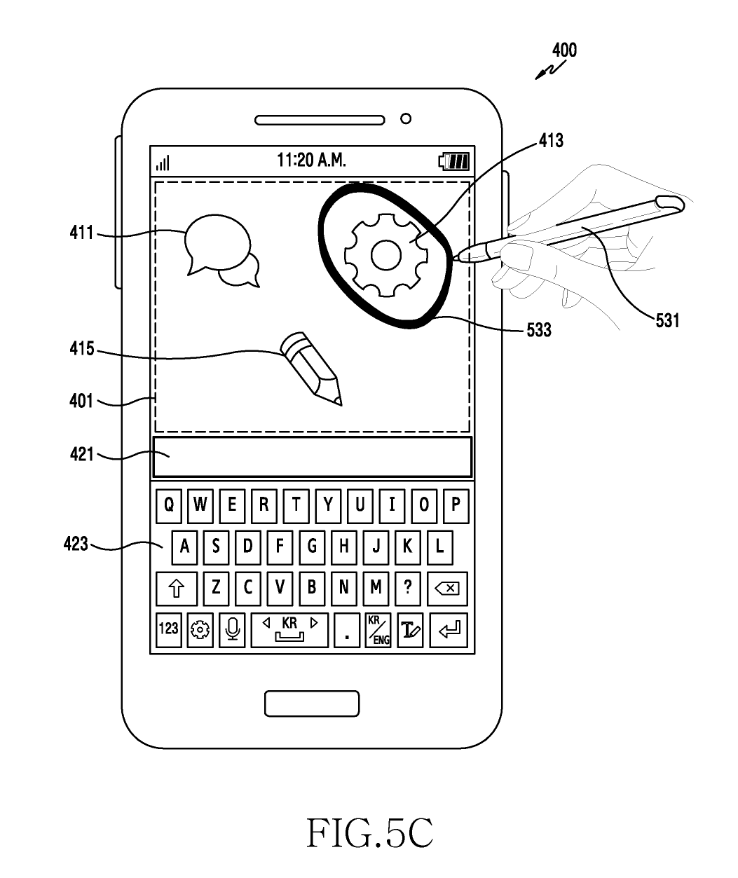

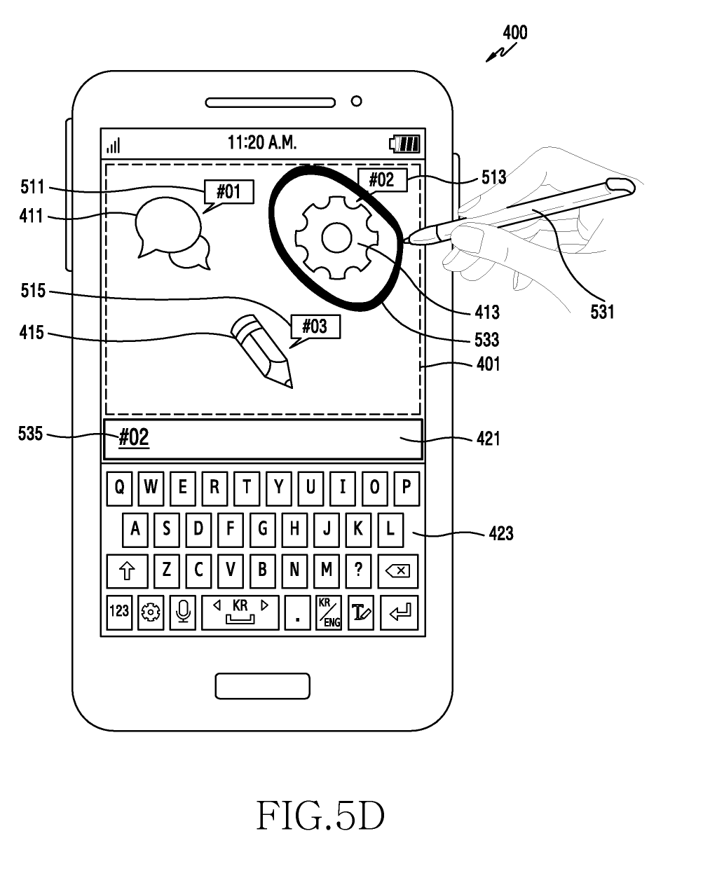

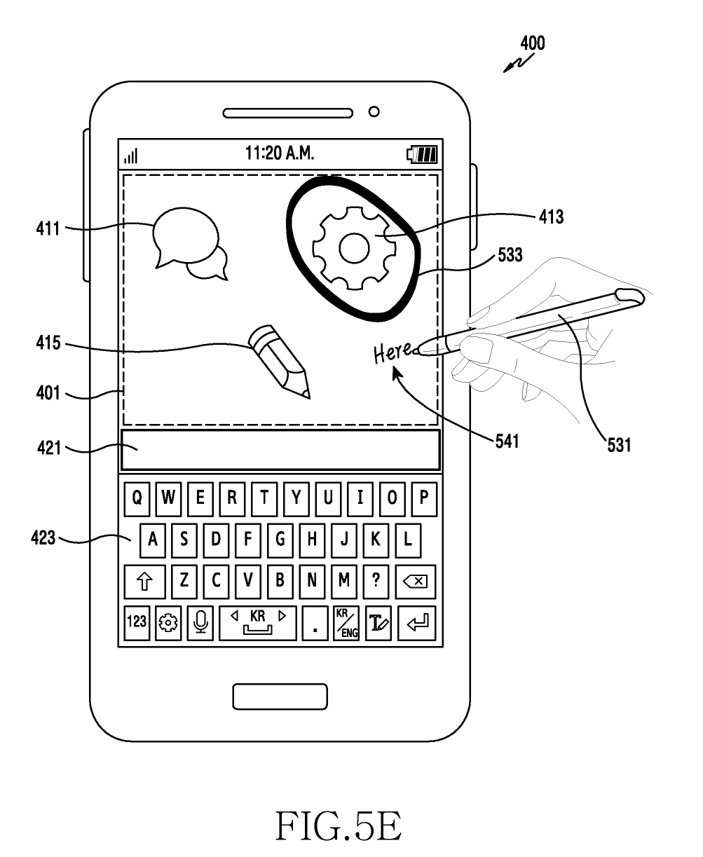

Referring to FIG. 4, when a content display event occurs, an electronic device 400 displays a first object 411, a second object 413, and a third object 415 that are included in content 401. Additionally, when the content display event occurs, the electronic device 400 assigns unique IDs 511, 513, 515 to the respective objects included in the content 401 as illustrated in FIG. 5B.

For example, the content is visual information such as a still image, a moving image, or a 3D image, each including a character, a symbol or sign, text, an icon or image, and the like.

For example, the objects are designated according to various conditions such as time, a creation tool, a region, a user, text, and the like.

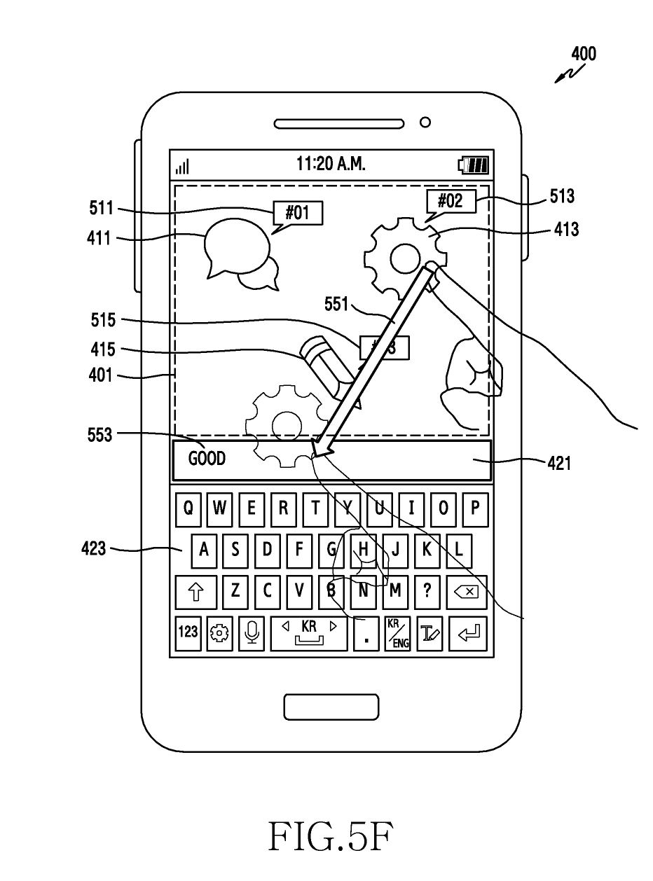

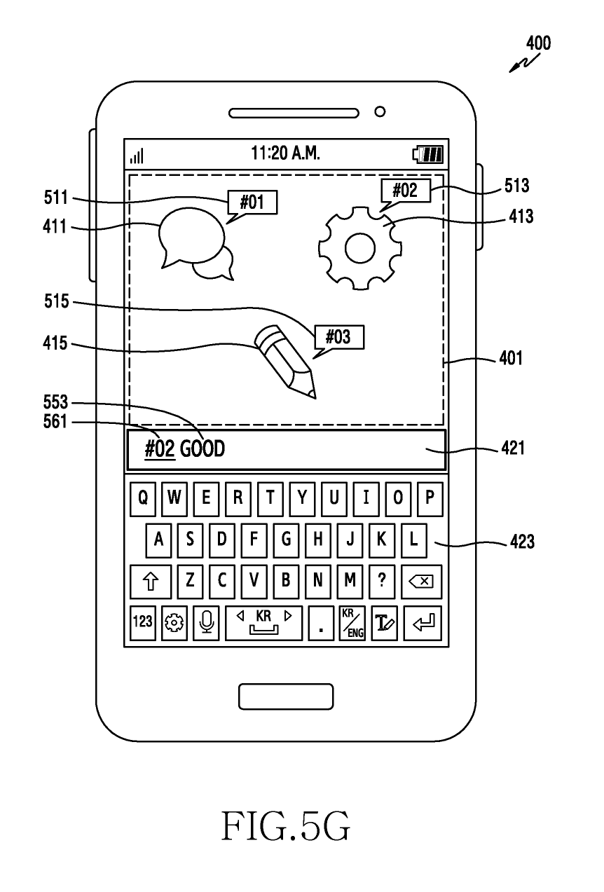

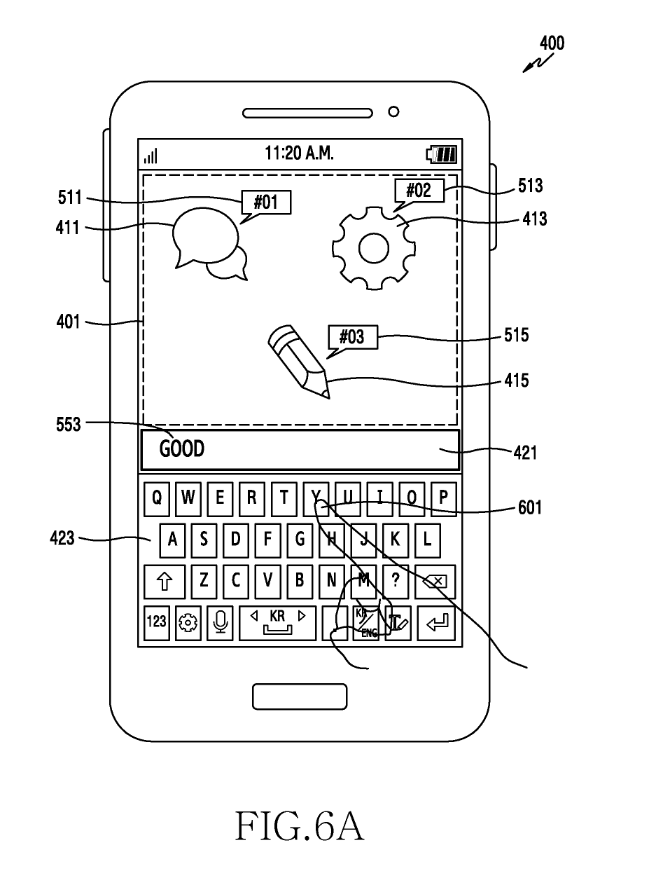

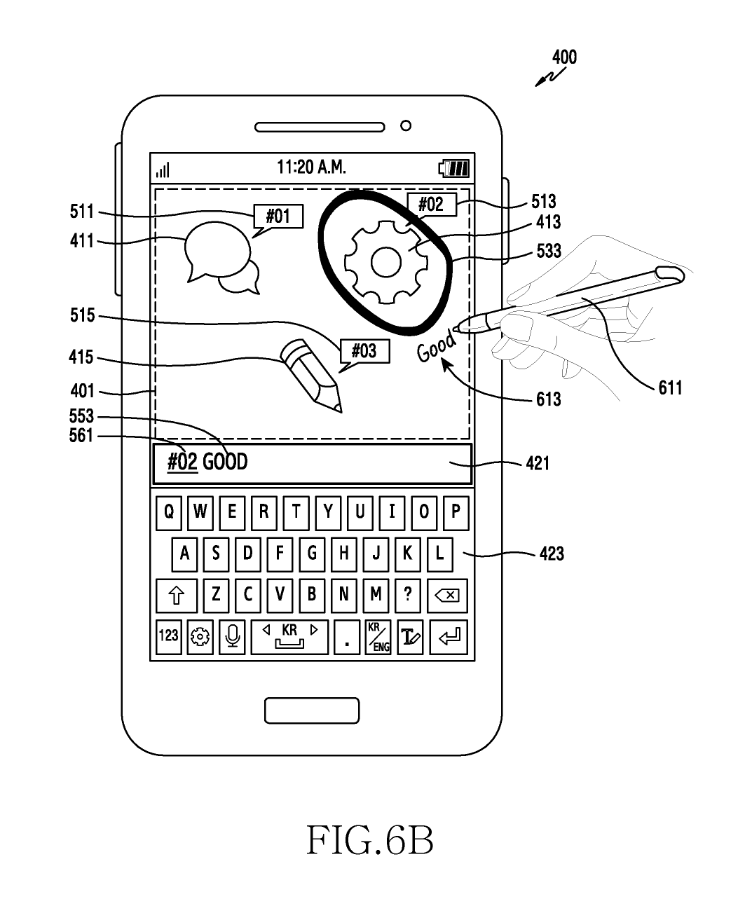

FIGS. 5A to 6B illustrate methods of selecting an object and including information in the object in an electronic device, according to various embodiments of the present disclosure.

Referring to FIG. 5A, the electronic device recognizes selection of an object based on a user's touch input on the object included in content. For example, when the user inputs a touch 501 on the second object 413 among the plurality of objects 411, 413, 415 included in the content region 401, the electronic device 400 recognizes that the second object 413 is selected.

According to certain embodiments, the electronic device recognizes selection of the plurality of objects based on the user's multi-touch.

According to certain embodiments, the electronic device recognizes selection of the objects based on the user's successive touch inputs entered within a reference time.

Referring to FIG. 5B, the electronic device identifies a unique ID for the selected object. For example, among the plurality of objects 411, 413, 415 included in the content region 401, the second object 413 is touched by the user. In certain embodiments, the electronic device 400 recognizes that the second object 413 is selected 521 and displays (403) the unique ID 513 of the second object 413 in an input window 421.

According to certain embodiments, when a unique ID for an object is input through the input window, the electronic device recognizes that the object corresponding to the input unique ID is selected.

Referring to FIG. 5C, based on an input related to an object included in the content region, the electronic device selects the corresponding object.

According to certain embodiments, when a closed curve 533 is drawn with an electronic pen 531, the electronic device 400 identifies that the second object 413 included in the region formed by the closed curve 533 is selected. In FIG. 5C, when the closed curve 533 is drawn with the electronic pen 531, the corresponding object is selected. However, without being limited thereto, the corresponding object may also be selected by an open curve.

Referring to FIG. 5D, the electronic device identifies the unique ID for the selected object. For example, when the closed curve 533 is drawn with the electronic pen 531, when the second object 413 is included in the region formed by the closed curve 533, the electronic device 400 recognizes that the second object 413 is selected and display (535) the unique ID 513 of the second object 413 in the input window 421.

According to certain embodiments, when a unique ID for an object is input through the input window, the electronic device recognizes that the object corresponding to the input unique ID is selected.

Referring to FIG. 5E, based on an input related to an object included in the content region, the electronic device selects the corresponding object.

According to certain embodiments, when text (e.g., “here”) 541 is input through the input window 421, the electronic device 400 recognizes that the second object 413 having a unique ID corresponding to the text (e.g., “here”) 541 is selected among the objects included in the content region.

Additionally, the method of selecting an object included in the content is implemented through various methods such as a voice input, a gesture input, gaze recognition through a camera, and the like.

FIG. 5F illustrates a method of including particular information in an object in an electronic device, according to various embodiments of the present disclosure.

Referring to FIG. 5F, when a user input is generated through a keypad 423, the electronic device 400 display information 553 input through the input window 421. When the second object 413 is selected by the user and dragged to the input window 421 while the information 553 has been input to the input window 421, the electronic device 400, for example, maps the information input to the input window 421 onto the second object 413. The electronic device 400 transmits information corresponding to the second object 413 and the information 533 to another electronic device such that the second object 413 and the information 553 are mapped with each other through the other electronic device (e.g., the server 205).

According to certain embodiments, illustrated in FIG. 5G, the electronic device, after mapping the information 553 input to the input window 421 onto the second object 413, displays both a unique ID 561 of the second object and the information 553 input by the user in the input window 421.

In FIG. 5G, the information 553 having been input by the user through the input window 421 and the unique ID 561 of the mapped object are displayed through the input window 421. However, without being limited thereto, the unique ID may not be displayed.

In FIGS. 5F and 5G, after the information 553 is input by the user through the input window 421, the object onto which the information will be mapped is selected; however, the present disclosure is not limited thereto. For example, when the user selects an object for information input and then inputs information, the electronic device maps the input information onto the selected object.

In FIGS. 5F and 5G, after the information 533 is input by the user through the input window 421, the input information is mapped onto any one object; however, the present disclosure is not limited thereto. For example, when the user inputs information and then selects a plurality of objects, the electronic device maps the information input by the user onto the plurality of selected objects.

According to certain embodiments, as illustrated in FIG. 6A, the information input to the input window 421 in FIGS. 5F and 5G is information input by a user 601 using the keypad 423.

According to certain embodiments, as illustrated in FIG. 6B, the information input to the input window 421 in FIGS. 5F and 5G is information 613 input by the user 601 using an electronic pen 611.

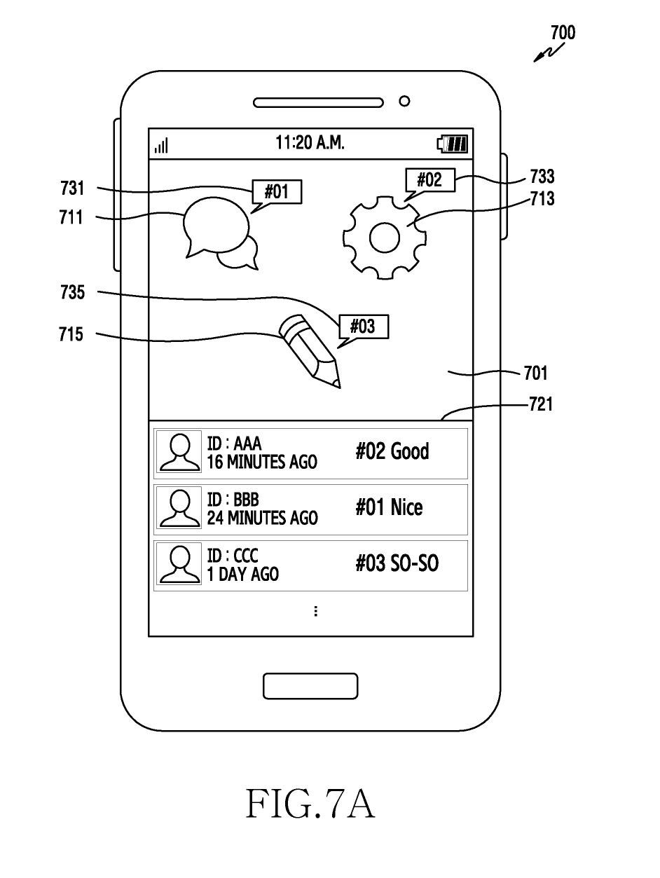

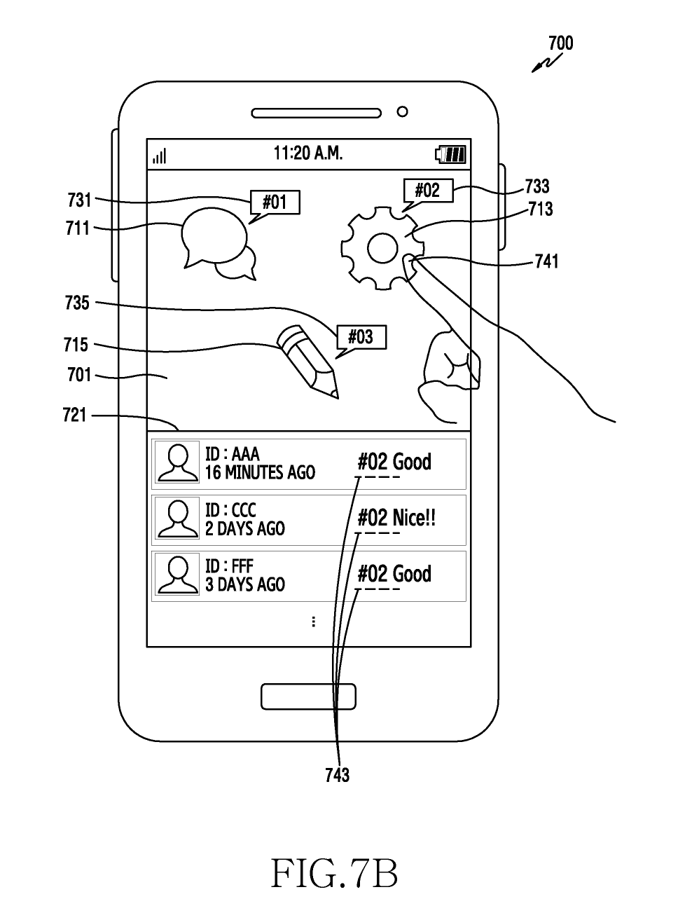

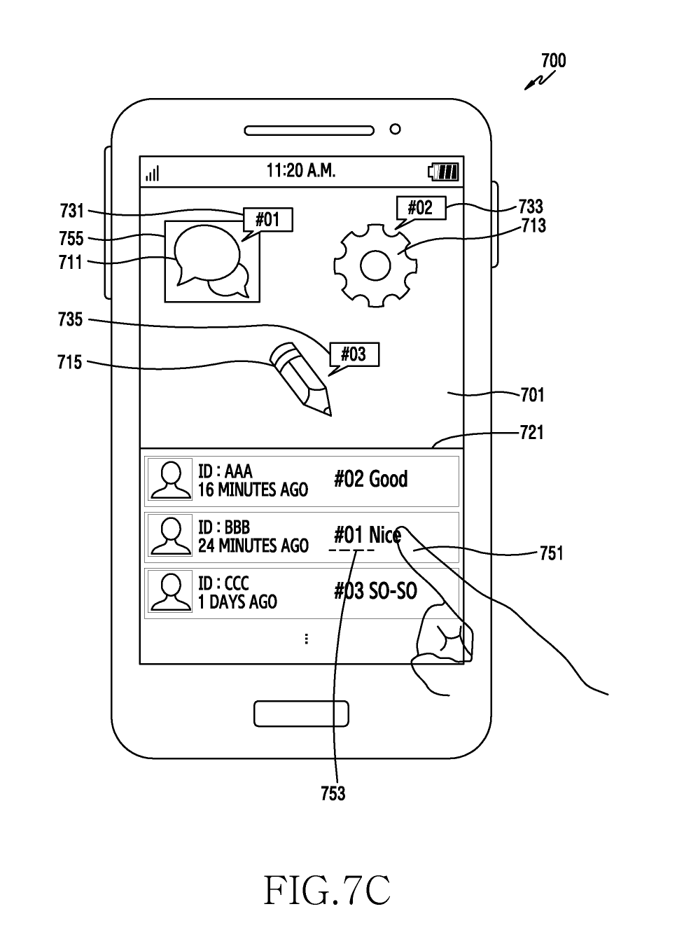

FIGS. 7A to 7C illustrate methods of displaying content and information corresponding to the content, according to various embodiments of the present disclosure.

Referring to FIG. 7A, when a content display event occurs, an electronic device 700 displays, in a content region 701, a first object 711, a second object 713, a third object 715, a unique ID 731 of the first object 711, a unique ID 733 of the second object 713, and a unique ID 735 of the third object 715. At least one piece of information corresponding to each of the objects 711, 713, 715 included in the content display region 701 is included in an information providing region 721. According to certain embodiments, the at least one piece of information corresponding to each object includes at least one of a comment, a writer ID, a posting time, a unique ID, and a profile image for the corresponding object.

According to certain embodiments, based on a user's selection of an object, the electronic device provides information corresponding to the selected object. For example, as illustrated in FIG. 7B, when the user 741 selects the second object 713, the electronic device 700 displays information mapped onto the second object 713 among a plurality of pieces of information included in the information providing region 721. For example, the electronic device displays information having the same ID 743 as the unique ID 733 of the second object 713 selected by the user among the plurality of pieces of information included in the information providing region 721.

According to certain embodiments, based on selection of any one piece of information included in the information providing region, the electronic device displays the corresponding object. For example, as illustrated in FIG. 7C, when a user 751 selects any one piece of information, the electronic device 700 displays (755) the first object 711 corresponding to the selected information in such a manner that the first object 711 is distinguished from the other objects 713, 715. For example, the electronic device displays the first object 711 in such a manner that the first object 711 is distinguished from the other objects based on a unique ID 753 for the object in the information selected by the user among the plurality of pieces of information included in the information providing region 721.

FIG. 8 is a block diagram of an electronic device 801 according to various embodiments of the present disclosure.

The electronic device 801 constitutes, for example, all or a part of the electronic device 101 illustrated in FIG. 1. Referring to FIG. 8, the electronic device 801 includes at least one Application Processor (AP) 810, a communication module 820, a Subscriber Identifier Module (SIM) card 824, a memory 830, a sensor module 840, an input device 850, a display 860, an interface 870, an audio module 880, a camera module 891, a power management module 895, a battery 896, an indicator 897, and a motor 898.

The AP 810 controls a plurality of hardware or software components connected thereto by driving an operating system or an application program, process various types of data including multimedia data, and perform calculations. The AP 810 is embodied as, for example, a System on Chip (SoC). According to one embodiment, the AP 810 further includes a Graphic Processing Unit (GPU).

The communication module 820 (e.g., the communication interface 160) performs data transmission/reception in communication between the electronic device 801 (e.g., electronic device 101) and other electronic devices (e.g., the electronic device 104 and the server 106) connected thereto through a network. According to certain embodiments, the communication module 820 includes a cellular module 821, a Wi-Fi module 823, a BLUETOOTH (BT) module 825, a Global Positioning System (GPS) module 827, a Near Field Communication (NFC) module 828, and a Radio Frequency (RF) module 829.

The cellular module 821 provides a voice call, a video call, an SMS service, an Internet service, and the like through a communication network (e.g., LTE, LTE-A, CDMA, WCDMA, UMTS, WiBro, or GSM). Furthermore, the cellular module 821 identifies and authenticates an electronic device in a communication network using, for example, a subscriber identification module (e.g., the SIM card 824). According to one embodiment, the cellular module 821 performs at least some functions which the AP 810 provides. For example, the cellular module 821 performs at least a part of the multimedia control function.

According to one embodiment, the cellular module 821 includes a Communication Processor (CP). Furthermore, the cellular module 821 is embodied as, for example, an SoC. In FIG. 8, the elements, such as the cellular module 821 (e.g., communication processor), the memory 830, and the power managing module 895, are illustrated as elements separate from the AP 810. However, according to certain embodiments, the AP 810 includes at least some of the above-described elements (e.g., the cellular module 821).

According to one embodiment, the AP 810 or the cellular module 821 (e.g., the communication processor) loads instructions or data received from at least one of a non-volatile memory and other elements connected thereto to a volatile memory, and processes the loaded commands or data. Furthermore, the AP 810 or the cellular module 821 stores data received from or generated by at least one of other elements in a non-volatile memory.

The Wi-Fi module 823, the BT module 825, the GPS module 827, and the NFC module 828 includes, for example, a processor for processing data transmitted or received through the corresponding module. In FIG. 8, the cellular module 821, the Wi-Fi module 823, the BT module 825, the GPS module 827, and the NFC module 828 are illustrated as individual blocks. According to certain embodiments, at least some (e.g., two or more) of the cellular module 821, the Wi-Fi module 823, the BT module 825, the GPS module 827, and the NFC module 828 is included within one Integrated Chip (IC) or one IC package. For example, at least some of processors corresponding to the cellular module 821, the Wi-Fi module 823, the BT module 825, the GPS module 827, and the NFC module 828 (e.g., a CP corresponding to the cellular module 821 and a Wi-Fi processor corresponding to the Wi-Fi module 823) are implemented as one SoC.

The RF module 829 transmit or receive data, for example, an RF signal. Although not illustrated in the drawing, the RF module 829 may, for example, include a transceiver, a power amp module (PAM), a frequency filter, a low noise amplifier (LNA), or the like. In addition, the RF module 829 further includes an element for transmitting or receiving electronic waves over free air space in wireless communication, for example, a conductor, a conducting wire, or the like. In FIG. 8, the cellular module 821, the Wi-Fi module 823, the BT module 825, the GPS module 827, and the NFC module 828 are illustrated to share one RF module 829. According to certain embodiments, at least one of the cellular module 821, the Wi-Fi module 823, the BT module 825, the GPS module 827, and the NFC module 828 transmit or receive the RE signal through a separate RF module.

The SIM card 824 is a card including a subscriber identification module and is inserted into a slot formed in a particular portion of the electronic device. The SIM card 824 includes unique identification information (e.g., an integrated Circuit Card Identifier (ICCID)) or subscriber information (e.g., an International Mobile Subscriber identity (IMSI)).

The memory 830 (e.g., the memory 130) includes an internal memory 832 or an external memory 834. The internal memory 832 includes at least one of a volatile memory (e.g., a Dynamic Random Access Memory (DRAM), a Static RAM (SRAM), and a Synchronous Dynamic RAM (SDRAM)) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, and a NOR flash memory).

According to one embodiment, the internal memory 832 is a Solid State Drive (SSD). The external memory 834 further includes a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 834 is functionally connected to the electronic device 801 through various interfaces. According to certain embodiments, the electronic device 801 further includes a storage device (or storage medium) such as a hard drive.

The sensor module 840 measures a physical quantity or detects an operating state of the electronic device 801 and converts the measured or detected information into an electronic signal. The sensor module 840 includes, for example, at least one of a gesture sensor 840A, a gyro sensor 840B, an atmospheric pressure sensor 840C, a magnetic sensor 840D, an acceleration sensor 840E, a grip sensor 840F, a proximity sensor 840G, a color sensor 840H (e.g., red, green, and blue (RGB) sensor), a biometric sensor 840I, a temperature/humidity sensor 840J, an illumination sensor 840K, and an Ultra Violet (UV) sensor 840M. The sensor module 840 includes, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an infrared (IR) sensor, an iris sensor (not illustrated), or a fingerprint sensor (not illustrated). The sensor module 840 further includes a control circuit for controlling one or more sensors included therein.

The input device 850 includes a touch panel 852, a (digital) pen sensor 854, a key 856, or an ultrasonic input device 858. The touch panel 852 recognizes a touch input through at least one of, for example, a capacitive type, a resistive type, an infrared type, and an ultrasonic type. The touch panel 852 further includes a control circuit. In the case of the capacitive type, physical contact or proximity recognition is possible. The touch panel 852 further includes a tactile layer. In certain embodiments, the touch panel 852 provides a tactile reaction to a user.

The (digital) pen sensor 854 is implemented, for example, using the same or a similar method to receiving a user's touch input or using a separate recognition sheet. The key 856 includes, for example, a physical button, an optical key or a keypad. The ultrasonic input device 858 detects an acoustic wave with a microphone (e.g., a microphone 888) of the electronic device 801 through an input tool for generating an ultrasonic signal to identify data, and wireless recognition is possible therethrough. According to certain embodiments, the electronic device 801 receives a user input from an external device (e.g., a computer or server) connected thereto using the communication module 820.

The display 860 (e.g., the display 150) includes a panel 862, a hologram device 864, or a projector 866. The panel 862 is, for example, a Liquid Crystal Display (LCD), Active-Matrix Organic Light Emitting Diode (AM-OLED), or the like. The panel 862 is implemented to be, for example, flexible, transparent, or wearable. The panel 862 may also be configured as one module together with the touch panel 852. The hologram device 864 shows a stereoscopic image in the air using interference of light. The projector 866 projects light onto a screen to display an image. For example, the screen is located in the interior or on the exterior of the electronic device 801. According to certain embodiments, the display 860 further includes a control circuit for controlling the panel 862, the hologram device 864, or the projector 866.

The interface 870 includes, for example, a High-Definition Multimedia Interface (HDMI) 872, a Universal Serial Bus (USB) 874, an optical interface 876, or a D-subminiature (D-sub) 878. The interface 870 is included in, for example, the communication interface 160 illustrated in FIG. 1. The interface 870 includes, for example, a Mobile High-definition Link (MHL) interface, a Secure Digital (SD) card/Multi-Media Card (MMC) interface, or an Infrared Data Association (IrDA) standard interface.

The audio module 880 bilaterally converts a sound and an electronic signal. At least some elements of the audio module 880 are included in, for example, the input/output interface 140 illustrated in FIG. 1. The audio module 880 processes voice information input or output through, for example, a speaker 882, a receiver 884, earphones 886, or the microphone 888.

The camera module 891 captures a still image or a moving image, and according to certain embodiments, includes one or more image sensors a front sensor or a rear sensor), a lens (not illustrated), an Image Signal Processor (ISP) (not illustrated), or a flash (not illustrated) (e.g., an LED or a xenon lamp).

The power management module 895 manages power of the electronic device 801. Although not illustrated, the power management module 895 includes, for example, a Power Management Integrated Circuit (PMIC), a charger Integrated Circuit (IC), or a battery or fuel gauge.

The PMIC is mounted, for example, in integrated circuits or SoC semiconductors. The charging methods are classified into wired charging and wireless charging. The charger IC charges a battery and prevents inflow of excessive voltage or excessive current from a charger. According to certain embodiments, the charger IC includes a charger IC for at least one of the wired charging method and the wireless charging method. Examples of the wireless charging includes magnetic resonance charging, magnetic induction charging, and electromagnetic charging, and an additional circuit such as a coil loop, a resonance circuit, and a rectifier is added for the wireless charging.

The battery fuel gauge measures, for example, a residual quantity of the battery 896, or a voltage, a current, or a temperature during the charging. The battery 896 stores or generates electricity and supplies power to the electronic device 801 using the stored or generated electricity. The battery 896 includes, for example, a rechargeable battery or a solar battery.

The indicator 897 displays a particular status of the electronic device 801 or a part thereof (e.g., AP 810), for example, a booting status, a message status, a charging status, or the like. The motor 898 converts an electrical signal into mechanical vibration. Although not illustrated, the electronic device 801 includes a processing unit (e.g., a GPU) for supporting mobile TV. The processing device for supporting mobile TV processes media data according to standards such as, for example, a digital multimedia broadcasting (DMB), a digital video broadcasting (DVB) or a media flow.

The aforementioned elements of the electronic device according to various embodiments of the present disclosure are constituted by one or more components, and the name of the corresponding element varies with a type of electronic device. The electronic device according to various embodiments of the present disclosure includes at least one of the aforementioned elements. Some elements is omitted or other additional elements are further included in the electronic device. Further, some of the components of the electronic device according to the various embodiments of the present disclosure are combined to form a single entity, and thus, equivalently executes functions of the corresponding elements prior to the combination.

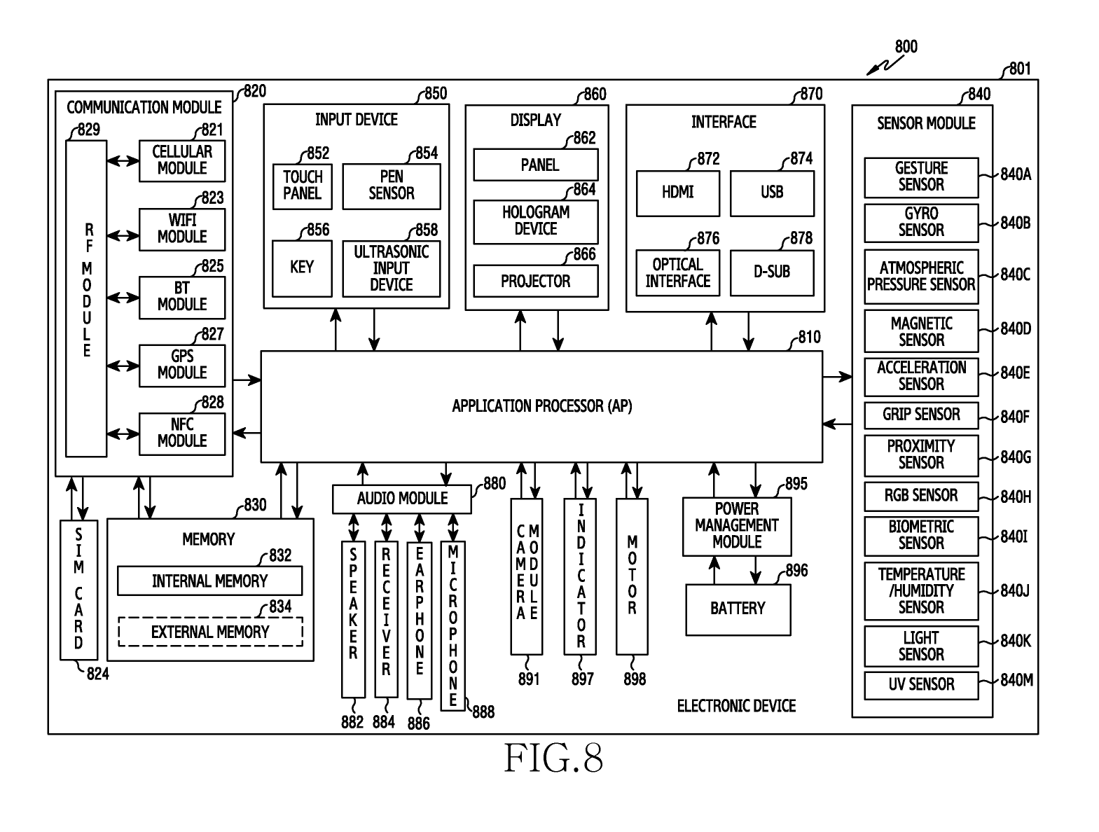

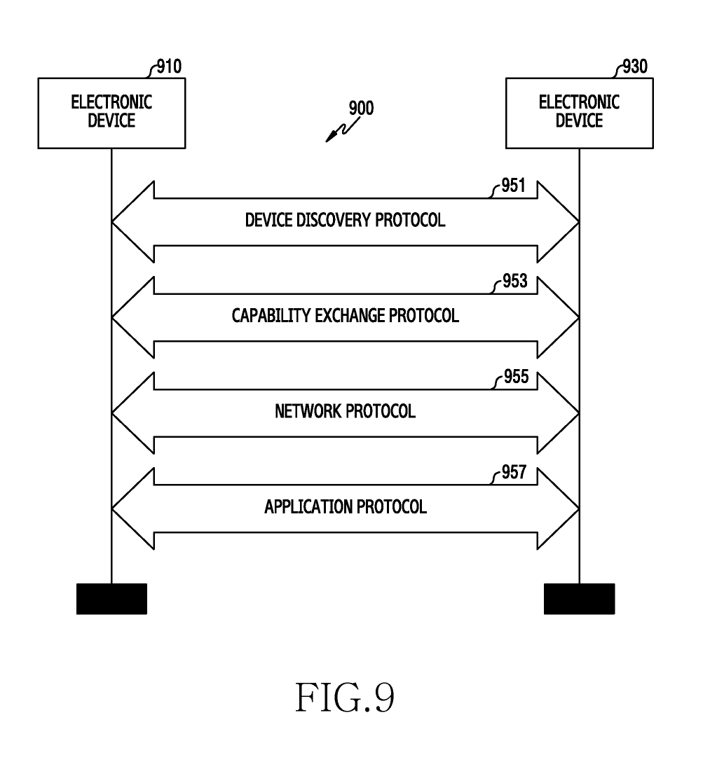

FIG. 9 illustrates a communication protocol 900 between a plurality of electronic devices (e.g., electronic devices 910, 930) according to various embodiments of the present disclosure.

Referring to FIG. 9, a communication protocol 900 includes, for example, a device discovery protocol 951, a capability exchange protocol 953, a network protocol 955, and an application protocol 957.

According to certain embodiments, the device discovery protocol 951 is a protocol that allows the electronic devices (e.g., the electronic devices 910, 930) to detect an external electronic device capable of communicating therewith or connect the detected external electronic device thereto. For example, using the device discovery protocol 951, the electronic device 910 (e.g., the electronic device 101) detects the electronic device 930 (e.g., the electronic device 104), as a device which communicates therewith, through a communication method (e.g., Wi-Fi, BT, or USB) which is used in the electronic device 910. For communication with the electronic device 930, the electronic device 910 acquires and stores identification information on the detected electronic device 930 using the device discovery protocol 951. For example, the electronic device 910 establishes communication with the electronic device 930, based on the identification information.

According to certain embodiments, the device discovery protocol 951 is a protocol for mutual authentication between a plurality of electronic devices. For example, the electronic device 910 performs authentication between the electronic device 910 and the electronic device 930 based on communication information (e.g., a Media Access Control (MAC) address, a Universally Unique Identifier (UUID), a SubSystem Identification (SSID), and an Information Provider (IP) address) for the connection with the electronic device 930.

According to certain embodiments, the capability exchange protocol 953 is a protocol for exchanging information related to a service function which is supported by at least one of the electronic device 910 and the electronic device 930. For example, the electronic device 910 and the electronic device 930 mutually exchange information related to currently provided service functions through the capability exchange protocol 953. The exchangeable information includes identification information indicating a particular service among a plurality of services which is supported by the electronic device 910 or the electronic device 930. For example, the electronic device 910 receives identification information of a particular service, provided by the electronic device 930, from the electronic device 930 through the capability exchange protocol 953. In this case, the electronic device 910 determines whether the electronic device 910 supports the particular service, based on the received identification information.

According to certain embodiments, the network protocol 955 (or data protocol or data/session protocol) is a protocol for controlling flow of data transmitted or received to provide a service between the electronic devices (e.g., the electronic devices 910, 930) connected to communicate with each other. For example, at least one of the electronic devices 910, 930 performs error control or data quality control using the network protocol 955. The network protocol 955 determines a transmission format of data transmitted or received between the electronic device 910 and the electronic device 930. In addition, using the network protocol 955, at least one of the electronic devices 910, 930 performs session management (e.g., session connection or session termination) for data exchange between the electronic devices.

According to certain embodiments, the application protocol 957 is a protocol for providing a procedure or information for exchanging data related to a service provided to an external electronic device. For example, the electronic device 910 (e.g., the electronic device 101) provides a service to the electronic device 930 (e.g., the electronic device 104 or the server 106) through the application protocol 957.

According to certain embodiments, the communication protocol 900 includes a standard communication protocol, a communication protocol designated by an individual or organization (e.g., a communication protocol self-designated by a communication device manufacturing company or a network supplying company) or a combination thereof.

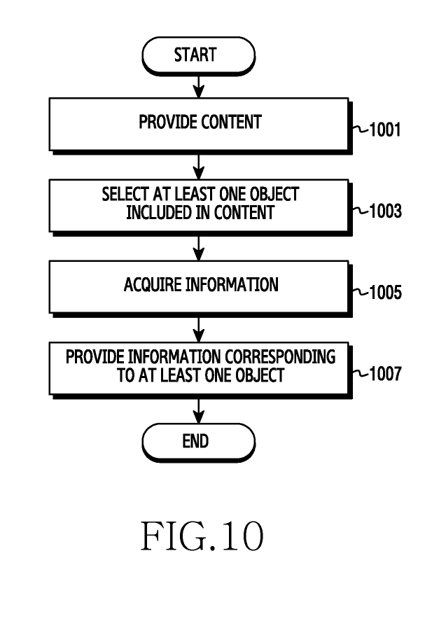

FIG. 10 is a flowchart illustrating a procedure for providing content in an electronic device, according to various embodiments of the present disclosure.

In operation 1001, the electronic device provides content including one or more designated objects. According to certain embodiments, the electronic device provides the content including the one or more designated objects through a display functionally connected to the electronic device (e.g., the electronic device 101).

In operation 1003, the electronic device selects at least one of the one or more designated objects. For example, when a selection menu (e.g., a hyperlink or a button) related to an object is provided, the electronic device detects an input related to the selection menu and selects the object related to the input. For example, when a unique ID related to an object is provided, if the unique ID is input in a search region where the unique ID is searched, the electronic device selects the object corresponding to the input unique ID. For example, when a closed curve is drawn with an electronic pen, the electronic device selects an object included in the region formed by the closed curve. The electronic device selects the corresponding object using an open curve. For example, when the content is a moving image, the electronic device selects at least a part of an object provided in the time domain of the content.

In operation 1005, the electronic device acquires information corresponding to the at least one selected object. According to certain embodiments, the electronic device acquires information input or drawn by a user. For example, the information includes text (e.g., a comment), an image, or audio data. According to certain embodiments, one piece of information is connected to a plurality of objects. For example, when the information is a comment, one comment corresponds to a plurality of objects. According to certain embodiments, the electronic device acquires information input within a designated time after the at least one object is selected. According to certain embodiments, the electronic device acquires the input information after selecting an object based on input of at least some information (e.g., a unique ID) related to the at least one object.

In operation 1007, the electronic device provides the acquired information corresponding to the at least one selected object. According to certain embodiments, the electronic device provides the acquired information to a region different from a content providing region. According to certain embodiments, the electronic device connects the provided information to the at least one object corresponding thereto and stores the information in a memory (e.g., the memory 130) functionally connected to the electronic device. According to certain embodiments, based on selection of at least some information connected to the at least one object, the electronic device selects an object connected to the at least some information.

According to certain embodiments, the electronic device provides additional information related to the connected object. For example, when information (e.g., a comment) is selected, the electronic device displays (e.g., highlight) an object related to the information in such a manner that the object is distinguished from other objects. According to certain embodiments, based on selection of at least some of one or more objects connected to the at least some information, the electronic device selects connection information connected to the at least some selected objects. According to certain embodiments, the electronic device provides the connection information therethrough. For example, the electronic device provides the connection information through a partial region (e.g., a region different from the region where the content is provided) of the display functionally connected thereto.

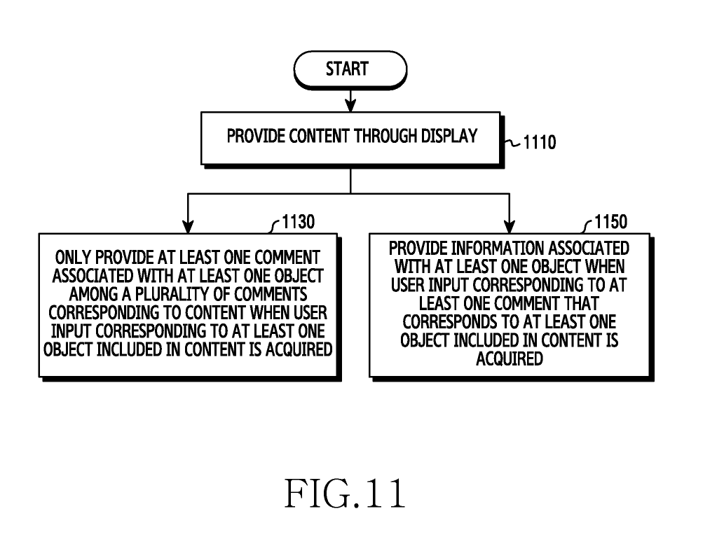

FIG. 11 is a flowchart illustrating a procedure for providing content in an electronic device, according to various embodiments of the present disclosure.

In operation 1110, the electronic device (e.g., the first or second electronic device 201 or 203) provides content through a display functionally connected thereto (e.g., included therein or connected thereto through wired/wireless communication).

According to certain embodiments, when the electronic device acquires a user input corresponding to at least one object (e.g., the second object 713) included in the content, the electronic device only provides, in operation 1130, at least one comment (e.g., information having the same ID 743) associated with the at least one object among a plurality of comments corresponding to the content.

According to certain embodiments, when the electronic device acquires a user input (e.g., a touch of the user 751) corresponding to at least one comment (e.g., a comment corresponding to the unique ID 753) that corresponds to at least one object included in the content, the electronic device provides, in operation 1150, information (e.g., the associated information 755) associated with the at least one object (e.g., the first object 711).

According to various embodiments, a method of providing content includes providing content through a display functionally connected to an electronic device, acquiring a user input corresponding to at least one object included in the content, and acquiring, through the electronic device, a comment that is able to be provided through the electronic device or another electronic device in relation to the at least one object.

According to various embodiments, the acquiring of the user input includes acquiring at least one of unique information or an image corresponding to the at least one object as the user input.

According to various embodiments, the display includes a first region and a second region, and the acquiring of the comment includes acquiring the comment through the second region when the content is provides through the first region.

According to various embodiments, the method further includes providing the comment based on another user input related to the at least one object.

According to various embodiments, the providing of the comment includes restricting provision of another comment corresponding to another object rather than the at least one object included in the content.

According to various embodiments, the method further include providing information corresponding to the at least one object based on another user input related to the comment.

According to various embodiments, the providing of the information include reproducing only the at least one object when the content includes a moving image.

According to various embodiments, the method further includes transmitting the comment to a server to connect the comment to the at least one object.

According to various embodiments, the method further includes storing the comment connected to the at least one object.

According to various embodiments, a method of providing content includes providing content through a display and only providing, through the electronic device, at least one comment associated with at least one object among a plurality of comments corresponding to the content when a user input corresponding to the at least one object included in the content is acquired.

According to various embodiments, the method includes providing, through the electronic device, information associated with the at least one object when a user input corresponding to the at least one comment is acquired.

According to various embodiments, the providing of the information associated with the at least one object includes reproducing only the at least one object of the content when the at least one object is a moving image.

The “module” used in various embodiments of the present disclosure refers to, for example, a “unit” including one of hardware, software, and firmware, or a combination of two or more of the hardware, software, and firmware. The “module” is interchangeable with a term, such as a unit, a logic, a logical block, a component, or a circuit. The “module” is a minimum unit of an integrated component element or a part thereof. The “module” is a minimum unit for performing one or more functions or a part thereof. The “module” is mechanically or electronically implemented. For example, the “module” according to various embodiments of the present disclosure includes at least one of an Application-Specific Integrated Circuit (ASIC) chip, a Field-Programmable Gate Arrays (FPGAs), and a programmable-logic device for performing operations which have been known or are to be developed hereafter,

According to various embodiments, at least a part of a device (for example, modules or functions thereof) or a method (for example, operations) according to the various embodiments of the present disclosure is embodied by, for example, a command stored in a computer readable storage medium in a form of a programming module. When the command is executed by one or more processors, the one or more processors perform a function corresponding to the command. The computer-readable storage medium is, for example, the memory 130. At least some of the programming modules are implemented (for example, executed) by, for example, the processor. At least a part of the programming module may, for example, include a module, a program, a routine, a set of instructions, or a process for performing at least one function.

The computer readable recording medium includes magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions includes high class language codes, which be executed in a computer by using an interpreter, as well as machine codes made by a compiler. The aforementioned hardware device is configured to operate as one or more software modules in order to perform the operation of various embodiments of the present disclosure, and vice versa.

A module or a programming module according to the present disclosure includes at least one of the described component elements, a few of the component elements is omitted, or additional component elements is included. Operations executed by a module, a programming module, or other component elements according to various embodiments of the present disclosure are executed sequentially, in parallel, repeatedly, or in a heuristic manner. Further, some operations are executed in a different order, some of the operations may be omitted, or other operations may be added.

According to various embodiments, in a storage medium having instructions stored therein, the instructions are configured to allow at least one processor to perform at least one operation when being executed by the at least one processor, and the at least one operation includes providing content through a display functionally connected to an electronic device, acquiring a user input corresponding to at least one object included in the content, and acquiring, through the electronic device, a comment that is able to be provided through the electronic device or another electronic device in relation to the at least one object.

According to various embodiments, the content providing method and device provides an object included in content and information (e.g., a comment) related to the object that are connected to each other, so that a user intuitively recognize the information related to the object.

In addition, according to various embodiments, the content providing method and device selectively provides only information related to an object desired by a user among one or more objects included in content, so that the user conveniently acquires the information related to the desired object.

Embodiments of the present disclosure provided in the present specifications and drawings are merely certain examples to readily describe the technology associated with embodiments of the present disclosure and to help understanding of the embodiments of the present disclosure, but may not limit the scope of the embodiments of the present disclosure. Therefore, in addition to the embodiments disclosed herein, the scope of the various embodiments of the present disclosure should be construed to include all modifications or modified forms drawn based on the technical idea of the various embodiments of the present disclosure. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method comprising;
providing content through a display functionally connected to an electronic device;
acquiring a user input corresponding to at least one object included in the content; and
acquiring, through the electronic device, a comment that is able to be provided through the electronic device or another electronic device in relation to the at least one object.

2. The method of claim 1, wherein acquiring the user input comprises:
acquiring at least one of unique information or an image corresponding to the at least one object as the user input.

3. The method of claim 1, wherein the display comprises a first region and a second region, and wherein acquiring the comment comprises acquiring the comment through the second region when the content is provided through the first region.

4. The method of claim 1, further comprising:
providing the comment based on another user input related to the at least one object.

5. The method of claim 4, wherein providing the comment comprises:
restricting provision of another comment corresponding to another object rather than the at least one object included in the content.

6. The method of claim 1, further comprising:
providing information corresponding to the at least one object based on another user input related to the comment.

7. The method of claim 6, wherein providing the information comprises reproducing only the at least one object when the content comprises a moving image.

8. The method of claim 1, further comprising:
transmitting the comment to a server to connect the comment to the at least one object.

9. The method of claim 1, further comprising:
storing the comment connected to the at least one object.

10. An electronic device comprising:
a display configured to provide content; and
a processor connected to the display, the processor configured to provide content through the display, acquire a user input corresponding to at least one object included in the content, and acquire a comment that is able to be provided through the electronic device or another electronic device in relation to the at least one object.

11. The electronic device of claim 10, wherein the at least one object is an object designated based on at least one of a user corresponding to the at least one object, and an output region, a generation time, and a generation method of the at least one object.

12. The electronic device of claim 10, wherein the processor is further configured to acquire an input corresponding to a region, where the at least one object is displayed, as the user input.

13. The electronic device of claim 10, wherein the processor is further configured to acquire at least one of unique information or an image corresponding to the at least one object as the user input.

14. The electronic device of claim 10, wherein the processor is further configured to provide the at least one selected object in such a manner that the selected object is distinguished from another object, based on the user input.

15. The electronic device of claim 14, wherein the processor is further configured to acquire information corresponding to a writing input acquired through the electronic device as the comment.

16. The electronic device of claim 10, wherein the processor is further configured to provide the comment based on another user input related to the at least one object.

17. The electronic device of claim 10, wherein the processor is further configured to reproduce only the at least one object of the content when the content comprises a moving image.

18. An electronic device comprising:
a display configured to provide content; and
a processor connected to the display, the processor is configured to provide the content through the display and only provide, through the electronic device, at least one comment associated with at least one object among a plurality of comments corresponding to the content when a user input corresponding to the at least one object included in the content is acquired.

19. The electronic device of claim 18, wherein the processor further configured to provide, through the electronic device, information associated with the at least one object when a user input corresponding to the at least one comment is acquired.

20. The electronic device of claim 19, wherein the processor is further configured to reproduce only the at least one object of the content when the at least one object is a moving image.
